(19) United States
(12) Patent Application Publication
(10) Pub. No.: US 2014/0108981 A1
(43) Pub. Date: Apr. 17, 2014

(54) WEIGHTED FOCUS NAVIGATION OF GRAPHICAL USER INTERFACE

(71) Applicant: MICROSOFT CORPORATION, Redmond, WA (US)

(72) Inventors: Gersh Payzer, Redmond, WA (US); Larry Olson, Issaquah, WA (US); Brandon C. Furtwangler, Woodinville, WA (US)

(73) Assignee: MICROSOFT CORPORATION, Redmond, WA (US)

(21) Appl. No.: 13/651,165

(22) Filed: Oct. 12, 2012

(51) Int. Cl. G06F 3/048

(52) U.S. Cl. 715/767

(57) ABSTRACT

A current focus element that has focus is identified from a plurality of focus elements in a user interface. User input corresponding to a navigation direction is received, and a rank is assigned to each of a plurality of eligible focus elements according to a focus algorithm. The focus algorithm may include a plurality of weight factors that are based on the navigation direction and the positions of eligible focus elements relative to a position of the current focus element. Focus is switched from the current focus element to a target focus element, which is selected from the plurality of eligible focus elements based on a rank of the target focus element.

### BACKGROUND

In some computing systems, a user may navigate between different elements in a user interface by switching focus. For example, focus may be switched from one element to another element by directional navigation provided via user input. Some directional navigation approaches may limit directional control by the user when switching focus between elements. Further, some navigation approaches may lack consideration for a plurality of factors related to the position of elements on the user interface relative to a direction of navigation when switching focus between elements. Further still, some navigation approaches may ignore a navigation history when switching focus between elements. In some cases, such navigation approaches may switch focus in a manner that does not match a user's navigational intent, which may result in a degraded user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments are disclosed that relate to switching focus in a user interface having a plurality of focus elements. For example, in one embodiment, a current focus element that has focus is identified from a plurality of focus elements in a user interface. User input corresponding to a navigation direction is received, and a rank is assigned to each of a plurality of eligible focus elements according to a focus algorithm. The focus algorithm may include a plurality of weight factors that are based on the navigation direction and the positions of eligible focus elements relative to a position of the current focus element. Focus is switched from the current focus element to a target focus element, which is selected from the plurality of eligible focus elements based on a rank of the target focus element.

### BRIEF DESCRIPTION OF THE DRAWINGS

FIG. 1 shows an example user interface according to an embodiment of the present disclosure.

FIG. 2 shows an example tree of the user interface of FIG. 1.

FIG. 3 shows an example focus tree of the user interface of FIG. 1.

FIG. 4 shows an example of a method for switching focus in a user interface according to an embodiment of the present disclosure.

FIG. 5 shows an example of a shadow weight factor included in a navigation algorithm according to an embodiment of the present disclosure.

FIG. 6 shows an example of a clip weight factor included in a navigation algorithm according to an embodiment of the present disclosure.

FIG. 7 shows an example of a history weight factor included in a navigation algorithm according to an embodiment of the present disclosure.

FIG. 8 shows an example of a primary axis weight factor included in a navigation algorithm according to an embodiment of the present disclosure.

FIG. 9 shows an example of a secondary axis weight factor included in a navigation algorithm according to an embodiment of the present disclosure.

FIG. 10 shows an example of navigation directions for navigating focus in a user interface.

FIG. 11 shows an example of diagonal navigation in a user interface according to an embodiment of the present disclosure.

FIG. 12 shows an example of three-dimensional navigation in a user interface according to an embodiment of the present disclosure.

FIG. 13 shows an example of a computing system according to an embodiment of the present disclosure.

### DETAILED DESCRIPTION

The present description provides navigation approaches for switching between focus elements in a user interface in a manner that preserves a user's navigational intent. More particularly, the navigation approaches employ a focus algorithm that includes a plurality of weight factors that are used to select a focus element to receive focus from a plurality of eligible focus elements in a user interface. In some embodiments, the plurality of weight factors in the focus algorithm may be based on the position of eligible focus elements relative to the position of a current focus element and a navigation direction provided via user input. The plurality of weight factors may be applied to assign a rank to each eligible focus element, and a target focus element to receive focus may be selected from the plurality of eligible focus elements based on rank. By considering a plurality of weight factors that are based on position relative to the position of the current focus element and the navigation direction in the focus algorithm, focus may be switched between focus elements in a manner that more accurately matches a user's navigation intent relative to a navigation approach that merely considers a single weight factor, does not consider the positions of elements and the navigation direction, and/or permits limited directional input (e.g., a single input direction).

Furthermore, in some embodiments, the focus algorithm may include a history weight factor that may be derived from at least one previous focus switching event. The history weight factor considers a navigation history when switching focus between elements in order to maintain switching continuity from one focus switching event to the next focus switching event. By considering the history weight factor in the focus algorithm, focus may be switched in a manner that more accurately matches a user's navigational intent relative to a navigation approach that ignores a focus switching history.

As used herein, focus means to place priority on, or bring attention to a focus element above other focus elements in the user interface. For example, focus may be indicated by a visual cue that differentiates a current focus element that has focus from other focus elements. A focus element may include any suitable element or object in a user interface that is capable of receiving focus or is selectable via a navigation direction provided by user input. In particular, a navigation direction may correspond to user input that indicates a direction in the user interface in which the user desires to switch focus, as opposed to point-and-click or other navigation paradigms. It will be appreciated that the navigation approaches described herein may be broadly applicable to different user interface frameworks and computing systems.

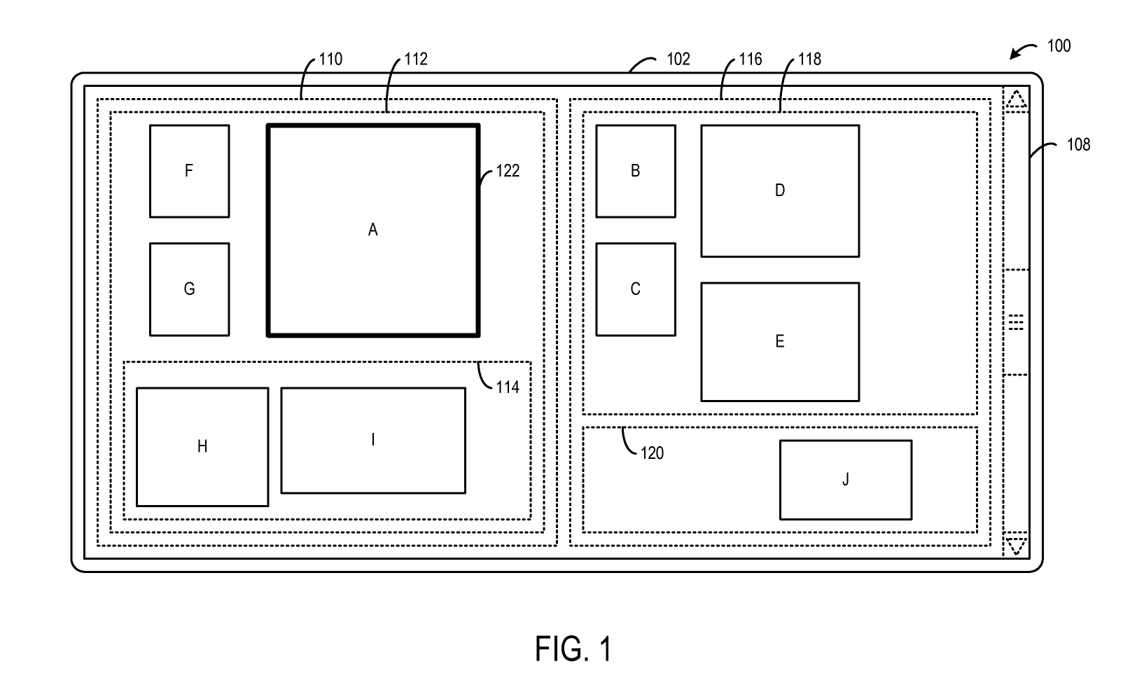

FIG. 1 shows an example user interface 100, herein depicted as a two-dimensional (2D) graphical user interface (GUI). It will be appreciated that the user interface may take any suitable form. For example, in some embodiments, the user interface may be a three-dimensional (3D) GUI.

The user interface 100 includes a plurality of elements 102 that represents information and actions available to a user through manipulation of some of the plurality of elements 102. In particular, the plurality of elements 102 may include a plurality of non-focus elements (e.g., scroll view 108) and a plurality of focus elements (e.g., focus element A).

The plurality of non-focus elements may not be capable of receiving focus. In the illustrated embodiment, the plurality of non-focus elements are indicated by dashed lines, although in some cases, the non-focus elements may not actually be visible to a user in the user interface. The plurality of non-focus elements may include various structural elements that define a relationship, spatial, hierarchical or otherwise, between elements in the user interface 100. Further, the plurality of non-focus elements may include visual elements that merely are not selectable or are not capable of receiving focus. As depicted, the plurality of non-focus elements include a scroll view 108, a left panel 110, an outer pane 112 that is nested in the left panel 110, an inner pane 114 that is nested in the outer pane 112, a right panel 116, and an upper pane 118 and a lower pane 120 that are nested in the right panel 116. Other non-limiting examples of non-focus elements may include backgrounds, layers, grids, labels, headers, etc. It will be appreciated that a non-focus element may be any suitable element or object that cannot receive focus in the user interface.

The plurality of focus elements may be capable of receiving focus, such as through directional navigation provided via user input. In the illustrated embodiment, the plurality of focus elements includes focus elements A, B, C, D, E, F, G, H, I, and J. Focus element A is a current focus element 122 that has focus as indicated by a bold border that is thicker than the borders of the other focus elements. Non-limiting examples of focus elements include action buttons, menu items, application launch icons, shortcut icons, links, etc. It will be appreciated that a focus element may be any suitable element or object that can receive focus in the user interface.

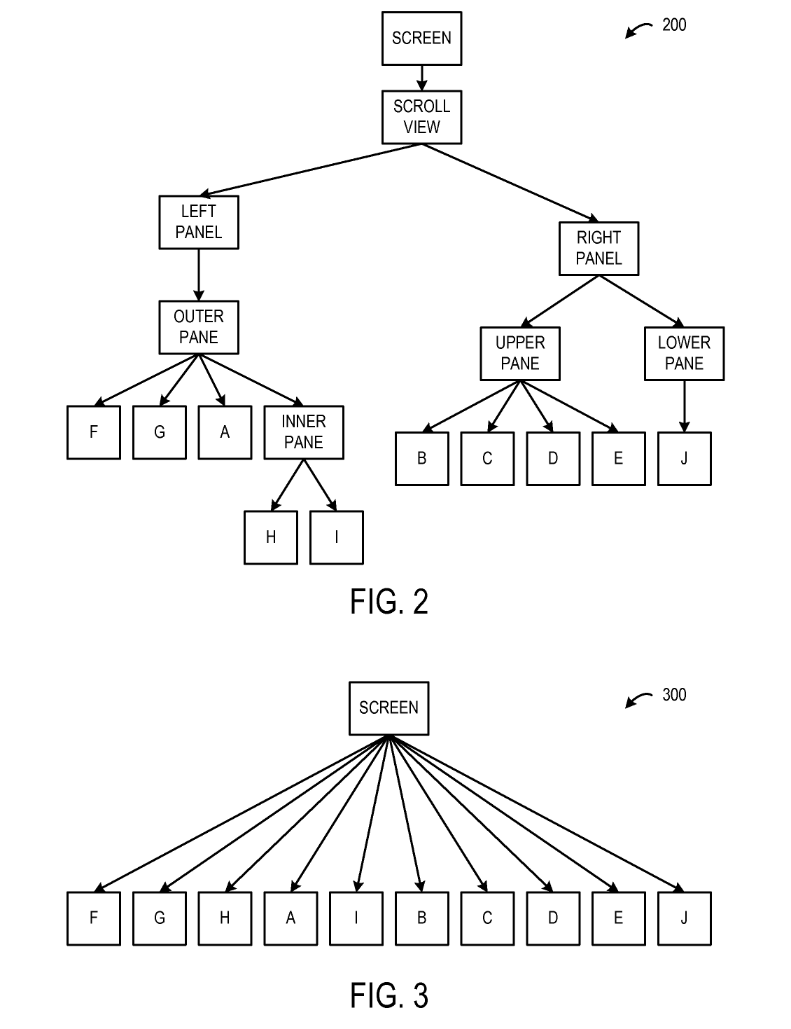

The plurality of elements 102 may be organized into a tree data structure that defines a hierarchical relationship of the plurality of elements 102. In one example, the tree structure includes a document object model (DOM) that defines attributes that are associated with each element, and how the elements and attributes can be manipulated. FIG. 2 shows an example tree 200 of the plurality of elements 102 in the user interface 100 of FIG. 1. At a root node of the tree 200 is the user interface (or screen). The screen has the scroll view as a single child. The scroll view has the left panel and the right panel as children. The left panel has the outer pane as a single child. The outer pane has focus elements F, G, and A, as well as the inner pane as children. The inner pane has focus elements H and I as children. The right panel has the upper pane and the lower pane as children. The upper pane has focus elements B, C, D, and E as children. The lower pane has focus element J as a single child.

For purposes of simplicity, the tree 200 may have fewer nodes relative to an actual real-world application of a tree that defines a graphical user interface, which typically may be very complex. Moreover, a real-world tree typically may include many non-focus elements, and a comparatively small number of focus elements. Due to the overall complexity of the tree as well as the imbalance between the number of non-focus and focus elements, a focus algorithm that is applied to the nodes of the tree to select a focus element to receive focus may be quite complex.

Furthermore, if navigation were based solely on traversing the tree structure, then a user's navigational intent may not be preserved in some cases. For example, in general, a user may expect focus navigation to work based on the elements that are visible. However, in some cases, the tree structure of the elements may be significantly different than would be indicated by the visual appearance of the user interface, because some non-focus elements may not be visible to the user.

For example, referring back to FIG. 1, if focus element J is the current focus element that has focus, and a user provides a navigation direction going left, then the user would expect to switch focus from focus element J to focus element I. However, because the inner pane 114 is nested in the outer pane 112, neither of which is visible by the user, under some schemes focus could instead switch from focus element J to focus element A. For example, focus navigation based solely on the tree 200 would switch focus to focus element A, because it is hierarchically higher up the tree 200 than focus element I. In this example, a spatial linear continuity of navigation as expected by the user is not maintained, because focus switches spatially upward from focus element J to focus element A instead of moving spatially left from focus element J to focus element I.

Accordingly, the tree 200 may be segmented to extract the focus elements from the non-focus elements, and the tree 200 may be transformed into a focus tree that includes the focus elements and does not includes the non-focus elements. FIG. 3 shows an example focus tree 300 of the user interface of FIG. 1. At a root node of the focus tree 300 is the screen. The screen has focus elements F, G, H, A, I, B, C, D, E, and J as children. Because the non-focus elements are not included in the focus tree 300, the focus tree 300 has a different hierarchical relationship between nodes than the tree 200. For example, the focus tree 300 may have fewer levels and/or branches than the tree 200.

It will be appreciated that, in some cases, the focus tree may have a plurality of levels with multiple sets of parents and children. For example, a user interface that includes focus elements that are containers for other focus elements may create a focus tree with a plurality of levels. The focus tree may provide the basis for which the focus algorithm may be applied to determine a focus element to receive focus during focus switching events that matches a user's navigational intent.

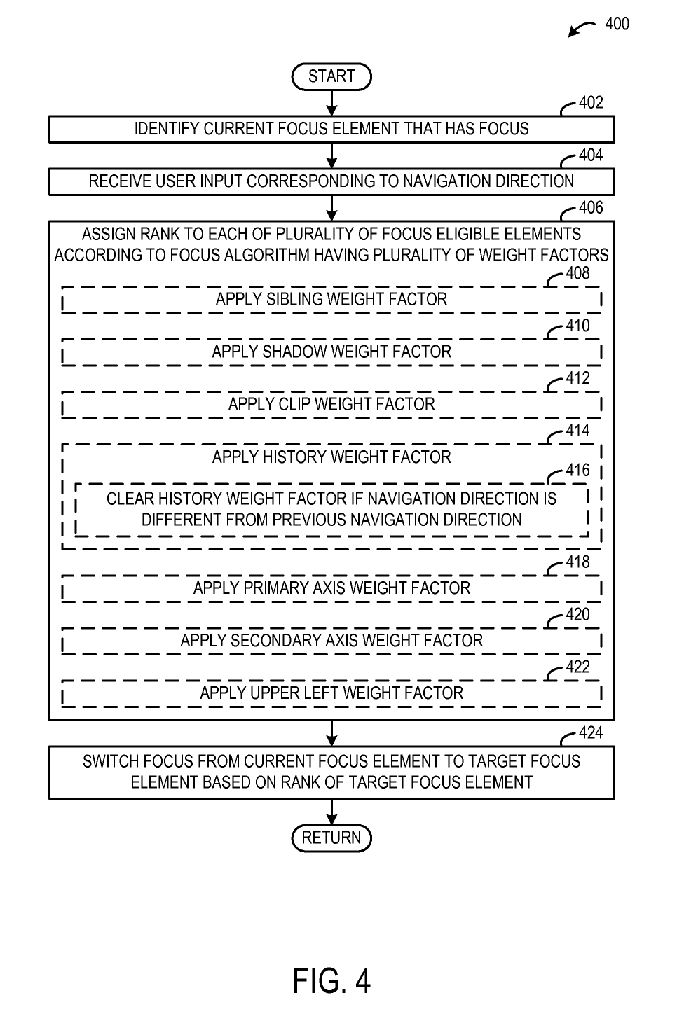

FIG. 4 shows an example of a method 400 for switching focus in a user interface according to an embodiment of the present disclosure. Throughout discussion of the method 400, FIGS. 1 and 5-10 may be referenced for more detailed explanation.

At 402, the method 400 includes identifying a current focus element that has focus from a plurality of focus elements in a user interface. In FIG. 1, the current focus element is focus element A, which is identified visually by a bold border. The current focus element may act as a positional reference that is used by the focus algorithm to determine future navigation between focus elements. Any suitable programming technique may be used to track which focus element currently has focus (e.g., a flag).

At 404, the method 400 includes receiving user input corresponding to a navigation direction. In one example, the navigation direction may be one of four cardinal directions or one of four ordinal directions.

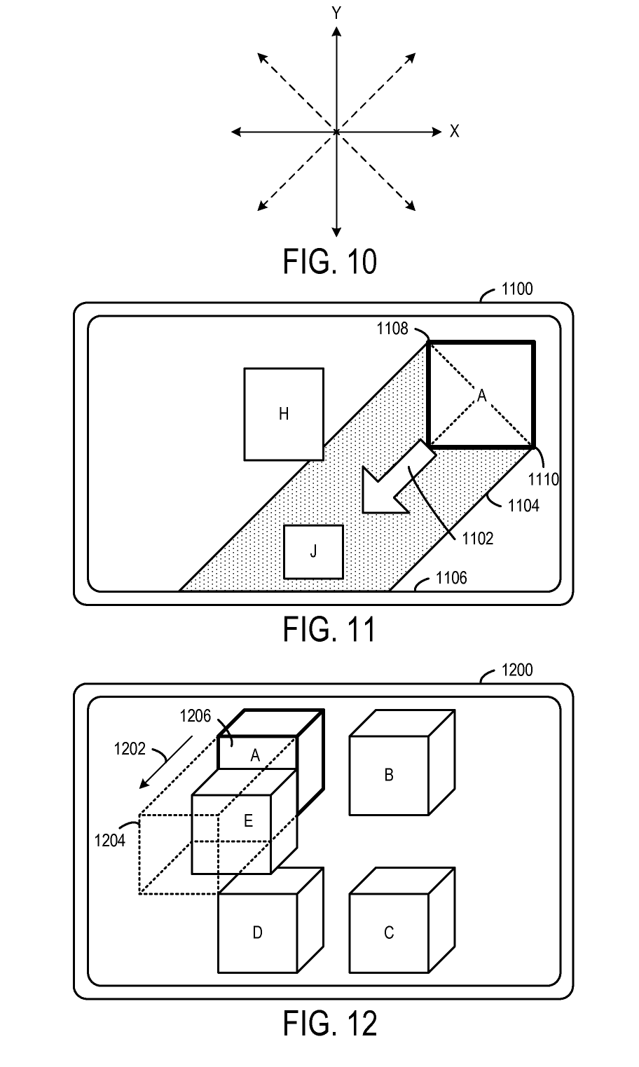

FIG. 10 shows an example of the four cardinal direction and the four ordinal directions. The four cardinal directions correspond to the directions along the X and Y axes. The four cardinal directions may be referred to as up, down, left, and right. The four ordinal directions correspond to the directions along the axes that are rotated forty-five degrees relative to the X and Y axes indicated by dashed lines. The four ordinal directions may be referred to as upper right, lower right, lower left, and upper left. Furthermore, in 3D applications, the navigation direction may include additional cardinal directions and additional ordinal directions that correspond to a Z axis.

It will be appreciated that a user may provide user input corresponding to the navigation direction in virtually any suitable manner using virtually any suitable input device. Non-limiting examples of input devices that may be used by a user to provide a navigation direction include a key board, game controller, remote control, audio receiver (e.g., microphone), a video receiver (e.g., video/depth camera), etc.

At 406, the method 400 includes assigning a rank to each of a plurality of eligible focus elements according to a focus algorithm that includes a plurality of weight factors that are based on position relative to a position of the current focus element and the navigation direction. In other words, each eligible focus element may be weighted differently based on the position of that eligible focus element relative to the current focus element and relative to the navigation direction.

In some embodiments, the plurality of weight factors may add weight positively, such that a highest ranked eligible focus element may match a user's navigational intentions. In some embodiments, the plurality of weight factors may add weight negatively, such that a lowest ranked eligible focus element may match a user's navigational intentions.

If a focus element does not currently have focus, then that focus element may be eligible to receive focus and/or be assigned a rank. In other words, all focus elements other than the current focus element may be eligible focus elements.

In some embodiments, the current focus element may have a reference side that is dictated by the navigation direction. For example, if a navigation direction points to the right, the right side of the current focus element is considered the reference side. If a focus element is not positioned completely beyond the reference side in the navigation direction, then that focus element may not be eligible to receive focus and/or be assigned a rank. Correspondingly, only focus elements that are positioned completely beyond the reference side of the current focus element in the navigation direction may be eligible. In other embodiments, a focus object may be eligible even when not positioned completely beyond the reference side of the current focus element in the navigation direction. In some cases, a current focus element may not have a reference side (e.g. a circular focus element). In such cases, the reference side may be replaced by a reference point that is farthest in the navigation direction and that may be used to determine eligibility.

In some embodiments, the plurality of weight factors includes a sibling weight factor, and at 408, the method 400 includes applying the sibling weight factor to each eligible focus element that shares a parent focus element of a focus tree with the current focus element. The sibling weight factor skews the focus algorithm to give preference to siblings of the current focus element over other eligible focus elements. In other words, the sibling weight factor rewards eligible focus elements that are siblings of the current focus element or penalizes eligible focus elements that are not siblings of the current focus element. If no eligible focus elements are siblings of the current focus element, then the weight factor does not apply (or applies equally to all eligible focus elements).

In one example, in the focus tree 300 shown in FIG. 3, each of the focus elements F, H, I, B, C, D, E, and J are siblings of the current focus element A. Accordingly, in this example, each of the eligible focus elements may receive the same sibling weight factor according to the focus algorithm.

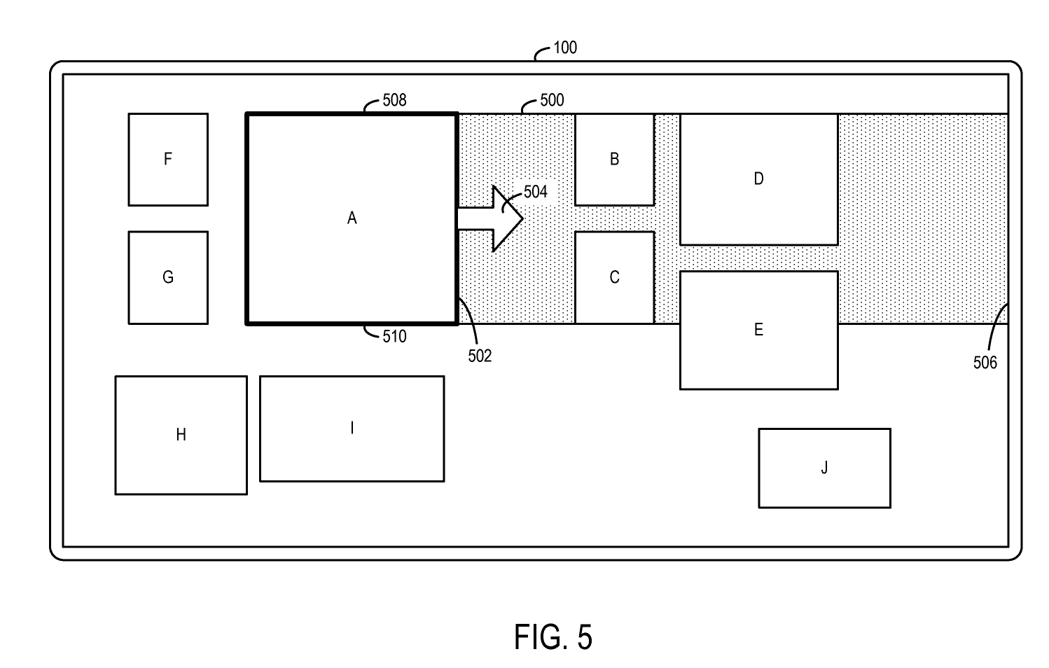

In some embodiments, the plurality of weight factors includes a shadow weight factor, and at 410, the method 400 includes applying the shadow weight factor to each eligible focus element that is positioned completely within a virtual shadow of the current focus element. During a focus switching event, a user may expect eligible focus elements that are aligned with the current focus element in the navigation direction to receive focus. Accordingly, a “virtual shadow.” as described below with reference to FIG. 5, may serve as a useful tool in predicting user intent. Further, the shadow weight factor may be included in the focus algorithm to give preference to eligible focus elements in this virtual shadow.

FIG. 5 shows an example of the shadow weight factor as applied to eligible focus elements in the user interface 100. In particular, a virtual shadow 500 extends from a reference side 502 of the current focus element A in a navigation direction 504 (to the right in this example) to an edge 506 of the user interface 100. In the illustrated example, the navigation direction 504 is schematically represented by an arrow. The navigation direction may be provided by user input via various user input devices (e.g., a D-pad of a game controller). The virtual shadow 500 is bound by an upper edge 508 and a lower edge 510 of the current focus element A. Note, in this example, focus elements that are positioned at least partially behind the reference side 502 of the current focus element A in the direction opposite of the navigation direction 504 are not eligible to receive focus (focus elements F, G, H, and I are not eligible). In this example, eligible focus elements B, C, and D are positioned completely within the virtual shadow 500 and eligible focus elements E and J are positioned not completely within the virtual shadow 500. The shadow weight factor rewards eligible focus elements B, C, and D or penalizes eligible focus elements E and J depending on the positive or negative nature of the weight factor in the focus algorithm.

In some embodiments, the plurality of weight factors includes a clip weight factor, and at 412, the method includes applying the clip weight factor to each eligible focus element that is positioned partially within and partially out of the virtual shadow.

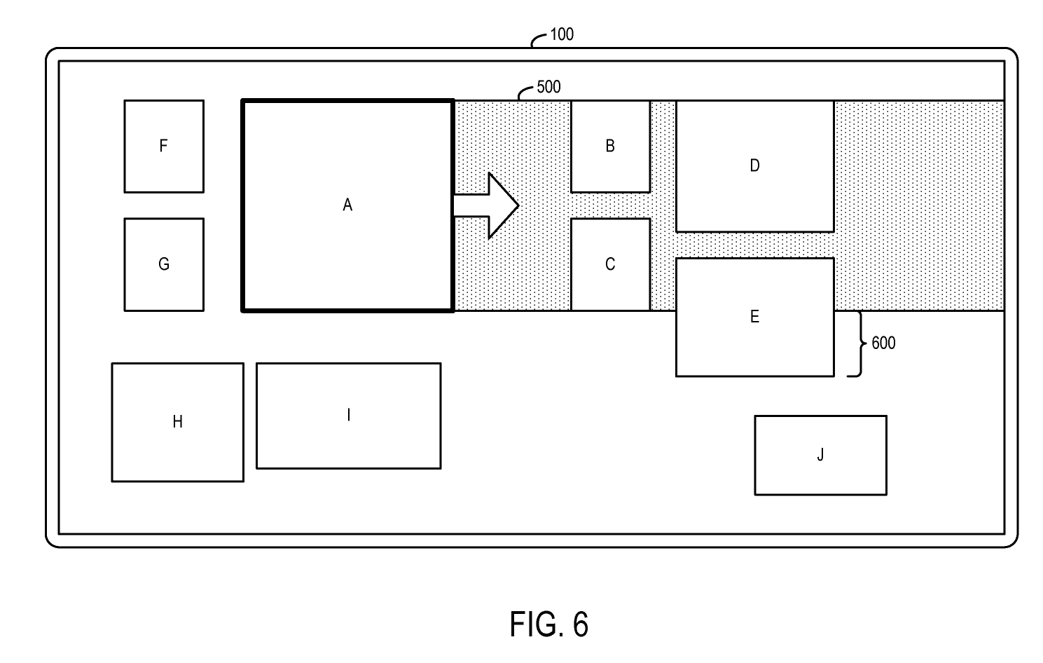

FIG. 6 shows an example of the clip weight factor as applied to eligible focus elements in the user interface 100. In particular, focus element E is positioned partially within and partially out of the virtual shadow 500. The clip weight factor is applied proportionally based on an amount 600 of the focus element E that is clipped by the virtual shadow 500. Depending on the positive or negative nature of the weight factor in the focus algorithm, the clip weight factor may account for the amount of the focus element E that is positioned within the virtual shadow 500 or the amount of the focus element E that is positioned out of the virtual shadow 500. Correspondingly, in some embodiments, the eligible focus elements that are positioned fully out of the virtual shadow 500 may be penalized for an entire amount or 100% of the clip weight factor.

In some embodiments, the plurality of weight factors includes a history weight factor, and at 414, the method 400 includes applying the history weight factor to each eligible focus element that is positioned completely within a previous virtual shadow of a previous focus element in a previous focus switching event along an axis aligned with the navigation direction. The history weight factor is used to skew the focus algorithm toward preferring eligible focus elements that are aligned with focus elements that previously had focus. In one example, the history weight factor may be used as a tie breaker when multiple eligible focus elements are positioned in a virtual shadow of the current focus element.

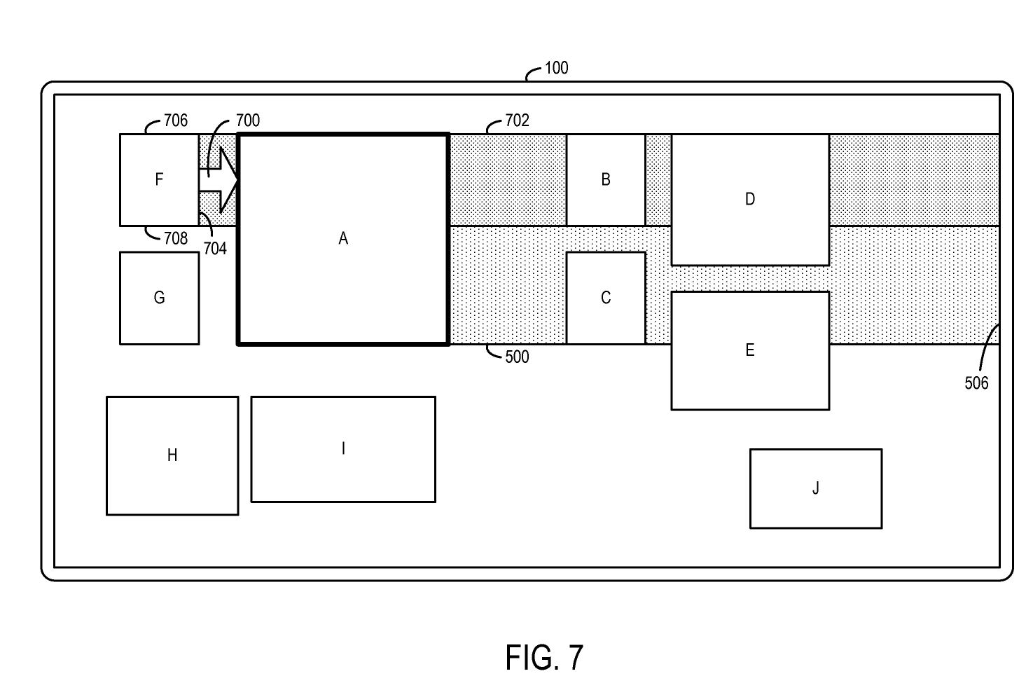

FIG. 7 shows an example of a history weight factor as applied to eligible focus elements in the user interface 100. In particular, since eligible focus elements B, C, and D are positioned completely within the virtual shadow 500 of the current focus element A, the history weight factor may be used as a tiebreaker. In this example, the previous focus switching event occurred when the user input provided a previous navigation direction 700 (right in this example), and focus switched from the previous focus element F to the current focus element A. Accordingly, the previous virtual shadow 702 extends from a reference side 704 of the previous focus element F in the previous navigation direction 700 to the edge 506 of the user interface 100. The previous virtual shadow 702 is bound by an upper edge 706 and a lower edge 708 of the previous focus element F. In this example, the eligible focus element B is positioned completely within the previous virtual shadow 702 and the eligible focus elements C, D, E, and J are not positioned completely within the previous virtual shadow 702. In other words, the history weight factor rewards eligible focus element B or penalizes eligible focus elements C, D, E, and J.

In some embodiments, the history weight factor may be based on a plurality of previous navigation events along an axis aligned with the navigation direction. By considering a plurality of previous navigation events, the history weight factor may more accurately correspond with the navigation history relative to an approach that ignores the navigation history or merely considers a single previous navigation event.

In some embodiments, at 416, the method 400 includes clearing the history weight factor in response to an axis of the navigation direction differing from an axis aligned with the previous navigation direction. Clearing the history weight factor may include not applying the history weight factor or making the history weight factor zero. For example, whenever the axis of the navigation direction changes between vertical and horizontal in different focus switching events, the history weight factor may be cleared. Further, in some cases, the history weight factor may be cleared whenever focus changes abruptly. For example, the history weight factor may be cleared whenever an application or another controlling entity sets focus explicitly.

In some embodiments, the plurality of weight factors may include a primary axis weight factor, and at 418, the method 400 includes applying the primary axis weight factor to each eligible focus element based on a distance along an axis that is aligned with the navigation direction between the current focus element and that eligible focus element. In some cases, the primary axis weight factor may be used to choose between eligible focus elements that are in the virtual shadow of the current focus element. In some cases, the primary axis weight factor may be used to choose between eligible focus elements that are equally spaced from outside the virtual shadow of the current focus element.

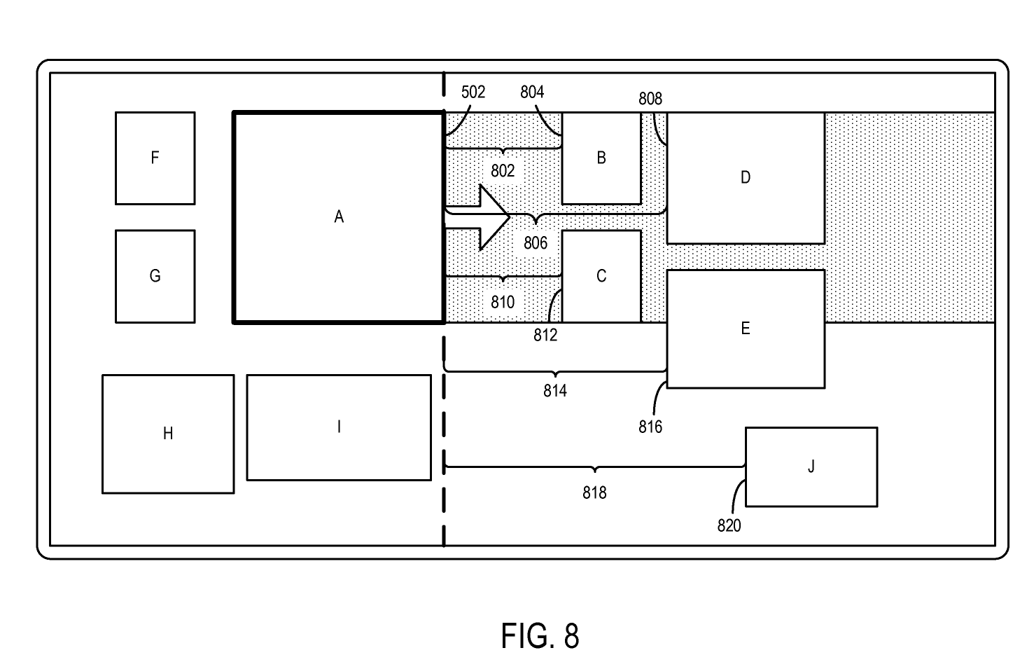

FIG. 8 shows an example of a primary axis weight factor as applied to eligible focus elements in the user interface 100. For each eligible focus element, a primary distance that the primary weight factor is based on is measured from the reference side 502 of the current focus element A (or a virtual line aligned with the reference side that extends to the edges of the user interface) to a potential side of an eligible focus element. In this example, the potential side of an eligible focus element is a side that is nearest to the reference side 502 of the current focus element A. In cases where an eligible focus element does not have a potential side (e.g., a circular focus element), then the potential side may be replaced by a potential point that is positioned nearest to the reference side 502.

As depicted, the primary distance 802 of the focus element B is measured from the reference side 502 of the current focus element A to the potential side 804 of the focus element B. The primary distance 806 of the focus element D is measured from the reference side 502 of the current focus element A to the potential side 808 of the focus element D. The primary distance 810 of the focus element C is measured from the reference side 502 of the current focus element A to the potential side 812 of the focus element C. The primary distance 814 of the focus element E is measured from the reference side 502 of the current focus element A to the potential side 816 of the focus element E. The primary distance 818 of the focus element J is measured from the reference side 502 of the current focus element A to the potential side 820 of the focus element J. In this example, focus elements B and C have the same primary distance and focus elements D and E have the same primary distance. The primary axis weight factor may reward focus elements B and C over focus elements D and E, and further over focus element J.

Note that the primary distance may be measured between any suitable set of sides or points as long as it is consistent between focus elements. For example, in some embodiments, the potential side of an eligible focus element may be a side that is farthest from the reference side of the current focus element.

In some embodiments, the plurality of weight factors may include a secondary axis weight factor, and at 420, the method 400 includes applying the secondary axis weight factor to each eligible focus element based on a distance along an axis that is perpendicular to the navigation direction between the current focus element and that eligible focus element.

In some embodiments, the secondary axis weight factor may apply to eligible focus elements that are positioned completely outside of the virtual shadow of the current focus element. Correspondingly, the secondary axis weight factor may not apply to eligible focus elements positioned completely or partially in the virtual shadow of the current focus element. In such embodiments, the secondary axis weight factor may be used to choose between eligible focus elements that are not in the virtual shadow of the current focus element.

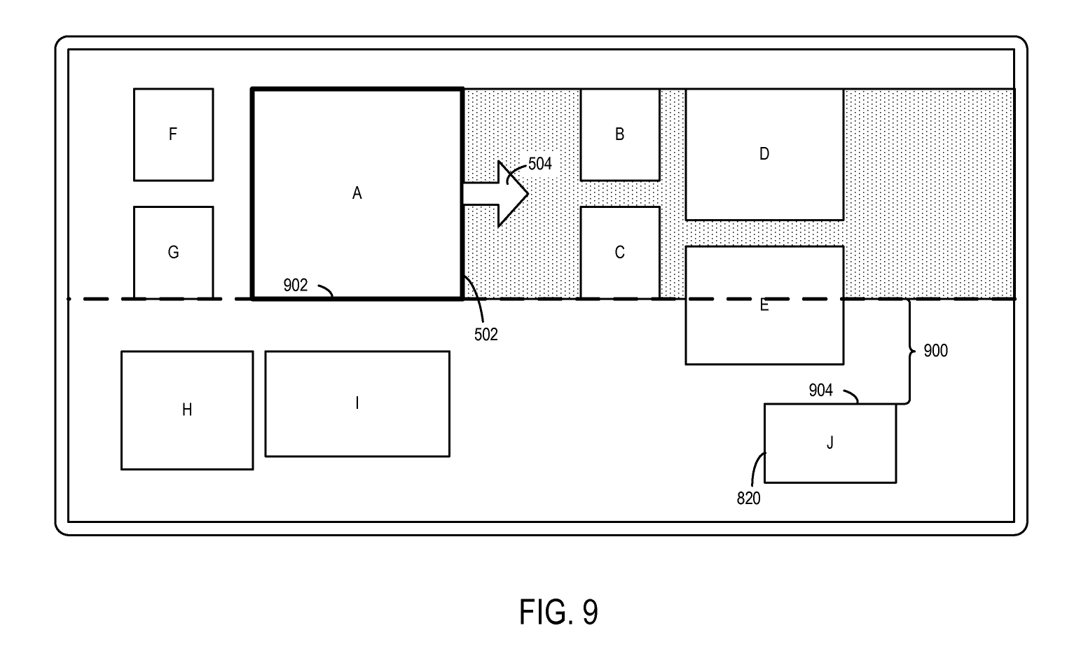

FIG. 9 shows an example of a secondary axis weight factor as applied to eligible focus elements in the user interface 100. For each eligible focus element positioned completely outside of the virtual shadow of the current focus element, a secondary distance that the secondary axis weight factor is based on is measured from a near side of the current focus element (or a virtual line extended along the near side to the edges of the user interface) to a near side of an eligible focus element. The near side of the current focus element is perpendicular to the reference side of the current focus element and correspondingly perpendicular to the navigation direction. The near side of the eligible focus element is perpendicular to the potential side of the eligible focus element and correspondingly perpendicular to the navigation direction.

In cases where the current focus element does not have a near side, then the near side may be replaced by a near point of the current focus element that is positioned on a line that is perpendicular to the navigation direction that is nearest the eligible focus element. In cases where the eligible focus element does not have a near side, then the near side may be replaced by a near point of the eligible focus element that is positioned on a line that is perpendicular to the navigation direction that is nearest the current focus element.

In the illustrated example, focus element J is the only eligible focus element that is positioned completely out of the virtual shadow 500. The secondary distance 900 is measured from a near side 902 of the current focus element A to a near side 904 of the eligible focus element J. The near side 902 of the current focus element A is perpendicular to the reference side 502 and the navigation direction 504. The near side 904 of the eligible focus element J is perpendicular to the potential side 820 and the navigation direction 504.

Note that the secondary distance may be measured between any suitable set of sides or points of the focus elements. For example, in some embodiments, the secondary distance may be measured from a near side of the current focus element to a far side of an eligible focus element. Note that the near side of the current focus element may be different for different eligible focus elements. For example, for an eligible focus element positioned above the current focus element, the near side may be the top side of the current focus element. For an eligible focus element positioned below the current focus element, the near side may be the bottom side of the current focus element. Accordingly, the secondary distance may be measured from different reference points for different focus elements based on a position of those focus elements.

In some embodiments, the plurality of weight factors may include an upper left weight factor, and at 422, the method 400 includes applying the upper left weight factor to each eligible focus element. The upper left weight factor may give a small penalty based on how far from an origin of the current focus element an eligible focus element is positioned. The upper left weight factor may be used to break ties between otherwise equally eligible focus elements.

In some embodiments, the plurality of weight factors may be prioritized relative to one another. For example, the plurality of weight factors may be arranged as a hierarchy of tie breakers with higher priority weight factors controlling selection and lower priority weight factors being used in case of a tie between eligible focus elements from the higher weight factors. In one example, a descending priority order of the weight factors is as follows: the sibling weight factor, the shadow weight factor, the history weight factor, the clip weight factor, the primary axis weight factor, the secondary axis weight factor, and the upper left weight factor. Although, it will be appreciated that the plurality of weight factors may be prioritized in any suitable order. Moreover, in some embodiments, one or more weight factors may be omitted from the focus algorithm.

In one example, the focus algorithm recites:

Rank=NotASiblingFactor*NotASiblingWeight+NotInShadowFactor*NotInShadowWeight+SecondaryAxisSeparation*SecondaryAxisSeparationWeight+PrimaryAxisSeparation*PrimaryAxisSeparationWeight+ClipFraction*ClipWeight+UpperLeftDistance*UpperLeftDistanceWeight

Non-limiting examples of values/ranges and weights for the plurality of weight factor are listed in Table 1 shown below.

TABLE 1

| Weight Factor | Value/Range | Example Weight |
|---|---|---|
| NotASiblingFactor | 0 if a sibling, 1 otherwise | 600.0 |
| NotInShadowFactor | 0 if in shadow, 1 otherwise | 300.0 |
| SecondaryAxisSeparation | 0 to ∞, a distance | 1.0 |
| PrimatyAxisSeparation | 0 to ∞, a distance | 1.0 |
| ClipFraction | 0 to 1 | 1.0 |
| UpperLeftDistance | 0 to ∞, a distance | 0.000001 |

The focus algorithm may be applied to each eligible focus element in order to assign a rank to each eligible focus element. The eligible focus elements may be ordered based on rank to form a ranking.

At 424, the method 400 includes switching focus from the current focus element to a target focus element selected from the plurality of eligible focus elements based on a rank of the target focus element. In one example, according to the focus algorithm shown above, a lowest ranked eligible focus element may be selected to receive focus. In another example, a highest ranked eligible focus element may be selected to receive focus.

In some cases, there may not be any eligible focus elements. Accordingly, focus may not be switched from the current focus element in this case. For example, focus may not be switched from a current focus element that is positioned on a right edge of the user interface, when the navigation direction is to the right. In some embodiments, in cases where there are no eligible focus elements in a navigation direction, the shadow may be “wrapped” around the user interface or extended from the opposite edge of the user interface to the current focus element. An eligible focus element that is positioned nearest to the opposite edge of the user interface in the virtual shadow may be selected to receive focus.

By considering a plurality of weight factors that are based on position relative to the position of the current focus element and the navigation direction as well as previous focus switching events in the focus algorithm, focus may be switched between focus element in a manner that more accurately matches a user's navigation intent

As discussed above, in some cases, the navigation direction may be one of four ordinal directions. These ordinal directions also may be referred to as diagonal directions. When the navigation direction for a focus switching event is a diagonal direction, the weight factors of the focus algorithm may be adjusted accordingly. FIG. 11 shows an example of diagonal navigation in a user interface 1100 according to an embodiment of the present disclosure. In this example, a navigation direction 1102 is the lower left ordinal direction. A virtual shadow 1104 extends from the current focus element A to an edge 1106 of the user interface 1100. The virtual shadow 1104 is bound by points 1108 and 1110. The points 1108 and 1110 are farthest points of the current focus element on a virtual line that is perpendicular to the navigation direction 1102. In this example, the focus switches to focus element J because it is positioned completely in the virtual shadow 1104.

As discussed above, in some cases, the user interface may be a virtual 3D space. FIG. 12 shows an example of three-dimensional navigation in a user interface 1200 according to an embodiment of the present disclosure. In this example, a plurality of focus elements (focus elements A, B, C, D, and E) is arranged in three dimensions in the user interface 1200. The current focus element A has focus. The navigation direction 1202 projects towards a view of the user along the Z axis. The virtual shadow 1204 extends in three dimensions along the navigation direction 1202. The virtual shadow 1204 is bound by a reference face 1206 of the current focus element A. The focus algorithm may be adapted for three dimensions by adding an additional axis weight factor that corresponds to separation between elements along the Z axis. In this example, the focus switches to focus element E based on the weight factors of the focus algorithm.

In some embodiments, the methods and processes described above may be tied to a computing system of one or more computing devices. In particular, such methods and processes may be implemented as a computer-application program or service, an application-programming interface (API), a library, and/or other computer-program product.

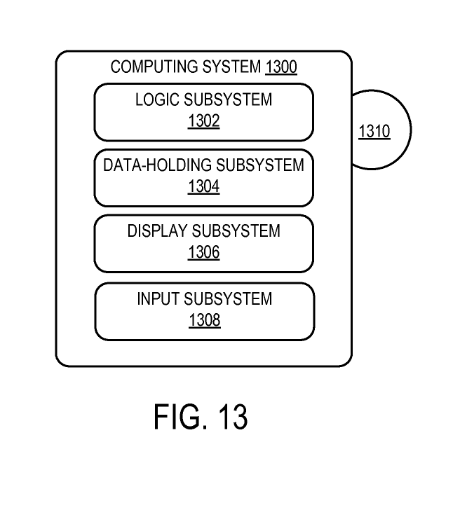

FIG. 13 shows an example of a computing system according to an embodiment of the present disclosure. The computing system can enact one or more of the methods and processes described above. Computing system 1300 is shown in simplified form. It will be understood that virtually any computer architecture may be used without departing from the scope of this disclosure. In different embodiments, the computing system 1300 may take the form of a mainframe computer, server computer, desktop computer, laptop computer, tablet computer, home-entertainment computer, network computing device, gaming device, mobile computing device, mobile communication device (e.g., smart phone), etc.

The computing system 1300 includes a logic subsystem 1302 and a storage subsystem 1304. The computing system 1300 may optionally include a display subsystem 1306, an input subsystem 1308, a communication subsystem 1310, and/or other components not shown in FIG. 13.

The logic subsystem 1302 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

The storage subsystem 1304 includes one or more physical, non-transitory, devices configured to hold data and/or instructions executable by the logic subsystem to implement the methods and processes described herein. When such methods and processes are implemented, the state of the storage subsystem 1304 may be transformed—e.g., to hold different data.

The storage subsystem 1304 may include removable media and/or built-in devices. The storage subsystem 1304 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. The storage subsystem 1304 may include volatile, nonvolatile, dynamic, static, read/write, read-only, random-access, sequential-access, location-addressable, file-addressable, and/or content-addressable devices.

It will be appreciated that the storage subsystem 1304 includes one or more physical, non-transitory devices. However, in some embodiments, aspects of the instructions described herein may be propagated in a transitory fashion by a pure signal (e.g., an electromagnetic signal, an optical signal, etc.) that is not held by a physical device for a finite duration. Furthermore, data and/or other forms of information pertaining to the present disclosure may be propagated by a pure signal.

In some embodiments, aspects of the logic subsystem 1302 and of the storage subsystem 1304 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

The terms “module.” “program,” and “engine” may be used to describe an aspect of the computing system 1300 implemented to perform a particular function. In some cases, a module, program, or engine may be instantiated via the logic subsystem 1302 executing instructions held by the storage subsystem 1304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module.” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, the display subsystem 1306 may be used to present a visual representation of data held by the storage subsystem 1304. This visual representation may take the form of a GUI. As the herein described methods and processes change the data held by the storage subsystem, and thus transform the state of the storage subsystem, the state of the display subsystem 1306 may likewise be transformed to visually represent changes in the underlying data. The display subsystem 1306 may include one or more display devices utilizing virtually any type of technology. Such display devices may be combined with the logic subsystem 1302 and/or the storage subsystem 1304 in a shared enclosure, or such display devices may be peripheral display devices.

When included, the input subsystem 1308 may comprise or interface with one or more user-input devices such as a keyboard, mouse, touch screen, or game controller. In some embodiments, the input subsystem may comprise or interface with selected NUI componentry. Such componentry may be integrated or peripheral, and the transduction and/or processing of input actions may be handled on- or off-board. Example NUI componentry may include a microphone for speech and/or voice recognition: an infrared, color, steroscopic, and/or depth camera for machine vision and/or gesture recognition; a head tracker, eye tracker, accelerometer, and/or gyroscope for motion detection and/or intent recognition; as well as electric-field sensing componentry for assessing brain activity.

The input subsystem 1308 may comprise or interface with one or more user input devices to receive user input that corresponds to a navigation direction, such as during a focus switching event. In one example, a user may provide the navigation direction by pressing one of a plurality of arrow keys on a keyboard. In another example, a user may provide the navigation direction by pressing one of a plurality of directional portions of a direction pad (D-pad) on a game controller. In yet another example, a user may provide the navigation direction by directing a joystick on a game controller in a particular direction. In yet another example, a user may provide the navigation direction by speaking a voice command that is detected by an audio receiver. In yet another example, a user may provide the navigation direction by performing a natural user input (NUI) gesture (e.g., point in a direction) that is detected by a video receiver. A user may provide user input that corresponds with a navigation direction to switch focus between focus elements in a user interface in a variety of ways via a variety of user input devices without departing from the scope of the present disclosure.

When included, the communication subsystem 1310 may be configured to communicatively couple the computing system 1300 with one or more other computing devices. The communication subsystem 1310 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem 1310 may allow the computing system 1300 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of switching focus in a user interface having a plurality of focus elements, comprising:
identifying a current focus element that has focus from the plurality of focus elements;
receiving user input corresponding to a navigation direction;
assigning a rank to each of a plurality of eligible focus elements according to a focus algorithm that includes a plurality of weight factors that are based on position relative to a position of the current focus element and the navigation direction, the plurality of eligible focus elements including focus elements positioned relative to the current focus element in a direction opposite the navigation direction; and
switching focus from the current focus element to a target focus element selected from the plurality of eligible focus elements based on a rank of the target focus element.

2. The method of claim 1, wherein the plurality of weight factors includes a sibling weight factor that is applied to each eligible focus element that shares a parent focus element of a focus tree with the current focus element.

3. The method of claim 1, wherein the plurality of weight factors includes a shadow weight factor that is applied to each eligible focus element that is positioned completely within a virtual shadow of the current focus element, wherein the virtual shadow extends from the current focus element in the navigation direction in the user interface.

4. The method of claim 3, wherein the plurality of weight factors includes a clip weight factor that is applied to each eligible focus element that is positioned partially within and partially out of the virtual shadow, wherein the clip weight factor is applied proportionally based on an amount of that eligible focus element that is clipped by the virtual shadow.

5. The method of claim 1, wherein the plurality of weight factors includes a history weight factor that is applied to each eligible focus element that is positioned completely within a previous virtual shadow of a previous focus element in a previous focus switching event along an axis aligned with the navigation direction.

6. The method of claim 1, wherein the plurality of weight factors includes a primary axis weight factor that is applied to each eligible focus element based on a distance along an axis that is aligned with the navigation direction between the current focus element and that eligible focus element.

7. The method of claim 1, wherein the plurality of weight factors includes a secondary axis weight factor that is applied to each eligible focus element based on a distance along an axis that is perpendicular to the navigation direction between the current focus element and that eligible focus element.

8. The method of claim 1, wherein the plurality of focus elements are arranged in three dimensions in the user interface.

9. The method of claim 1, wherein the navigation direction is one of four cardinal directions or one of four ordinal directions.

10. A method of switching focus in a user interface having a plurality of focus elements, comprising:
identifying a current focus element that has focus from the plurality of focus elements;
receiving user input corresponding to a navigation direction;
switching focus from the current focus element to a target focus element selected from a plurality of eligible focus elements based on a history weight factor derived from at least one previous focus switching event having a previous navigation direction along an axis aligned with the navigation direction, wherein the history weight factor is applied to each eligible focus element that is positioned completely within a previous virtual shadow of at least one previous focus element in the at least one previous focus switching event.

11. (canceled)

12. The method of claim 10, further comprising:
clearing the history weight factor in response to an axis of the navigation direction differing from an axis aligned with the previous navigation direction.

13. The method of claim 10, further comprising:
assigning a rank to each eligible focus element according to a focus algorithm that includes a plurality of weight factors including the history weight factor; and
switching focus from the current focus element to a target focus element selected from the plurality of eligible focus elements based on a rank of the target focus element.

14. The method of claim 13, wherein the plurality of weight factors includes a sibling weight factor that is applied to each eligible focus element that shares a parent focus element of a focus tree with the current focus element.

15. The method of claim 13, wherein the plurality of weight factors includes a shadow weight factor that is applied to each eligible focus element that is positioned completely within a virtual shadow of the current focus element, wherein the virtual shadow extends from the current focus element in the navigation direction in the user interface, and a clip weight factor that is applied to each eligible focus element that is positioned partially within and partially out of the virtual shadow, wherein the clip weight factor is applied proportionally based on an amount of that eligible focus element that is clipped by the virtual shadow.

16. The method of claim 13, wherein the plurality of weight factors includes a primary axis weight factor that is applied to each eligible focus element based on a distance along an axis that is aligned with the navigation direction between the current focus element and that eligible focus element, and a secondary axis weight factor that is applied to each eligible focus element based on a distance along an axis that is perpendicular to the navigation direction between the current focus element and that eligible focus element.

17. A computing system comprising:
a logic machine;
an input subsystem for receiving user input;
a storage machine holding instructions executable by the logic machine to:
identify a current focus element that has focus from a plurality of focus elements in a user interface;
receive via the input subsystem user input corresponding to a navigation direction;
assign a rank to each of a plurality of eligible focus elements other than the current focus element according to a focus algorithm that includes a plurality of weight factors that are based on position relative to a position of the current focus element and the navigation direction, wherein the plurality of weight factors includes a history weight factor derived from at least one previous focus switching event having a previous navigation direction along an axis aligned with the navigation direction, wherein the history weight factor is applied to each eligible focus element that is positioned completely within a previous virtual shadow of a previous focus element in a previous focus switchline event alone an axis aliened with the navigation direction; and
switch focus from the current focus element to a target focus element selected from the plurality of eligible focus elements based on a rank of the target focus element.

18. (canceled)

19. The computing system of claim 18, wherein the storage machine further holds instructions executable by the logic subsystem to:
clear the history weight factor in response to an axis of the navigation direction differing from an axis aligned with the previous navigation direction.

20. The computing system of claim 17, wherein the plurality of weight factors includes a sibling weight factor that is applied to each eligible focus element that shares a parent focus element of a focus tree with the current focus element, a shadow weight factor that is applied to each eligible focus element that is positioned completely within a virtual shadow of the current focus element, wherein the virtual shadow extends from the current focus element in the navigation direction in the user interface, a clip weight factor that is applied to each eligible focus element that is positioned partially within and partially out of the virtual shadow, wherein the clip weight factor is applied proportionally based on an amount of that eligible focus element that is clipped by the virtual shadow, a primary axis weight factor that is applied to each eligible focus element based on a distance along an axis that is aligned with the navigation direction between the current focus element and that eligible focus element, and a secondary axis weight factor that is applied to each eligible focus element based on a distance along an axis that is perpendicular to the navigation direction between the current focus element and that eligible focus element.
